(19) United States
(12) Patent Application Publication
(10) Pub. No.: US 2014/0258890 A1
(43) Pub. Date: Sep. 11, 2014

(54) SYSTEMS AND METHODS FOR ALTERING THE SPEED OF CONTENT MOVEMENT BASED ON USER INTEREST

(71) Applicant: YAHOO! INC., Sunnyvale, CA (US)

(72) Inventor: Gaurav Kamdar, Bangalore (IN)

(73) Assignee: YAHOO! INC., Sunnyvale, CA (US)

(21) Appl. No.: 13/791,401

(22) Filed: Mar. 8, 2013

(51) Int. Cl. G06F 3/0485

(52) U.S. Cl. CPC G06F 3/0485
USPC 715/760

(57) ABSTRACT

Techniques are provided which enhance a user's browsing experience by bringing greater attention to potentially relevant advertising content amidst non-relevant content. When a user access a browser to view content, information related to the interests of the user are used to identify relevant browser content to be used for potential advertisement targeting. The identified browser content is highlighted and stored for future use and the browser scroll settings are altered during the user's browsing session. In some embodiments, the settings are altered such that a user's ability to scroll through any identified browser content while displayed is slowed and the user's ability to scroll through the remaining browser content while displayed is quickened.

### BACKGROUND

Conventionally, targeted advertisements have focused primarily on determining relevant content for a particular user. However, less attention has been given to controlling user interaction with the targeted advertisement itself, an aspect which is as influential, if not more, than what is actually presented. For example, if a user is targeted with an advertisement, there are no means of ensuring the user will properly view or experience the advertising content amidst other content being displayed. This is especially true for advertisements which are displayed on handheld devices such as mobile phones and tablets, where the limitations on browser size often necessitate scrolling both horizontally and vertically to view the entire page. Such a scenario may obscure the intended impact and relevance of a targeted advertisement.

Accordingly, there is a need to enhance a user's browsing experience by bringing greater attention to potentially relevant advertising content amidst non-relevant content.

### SUMMARY

Some embodiments of the present invention provide systems and methods which take advantage of the scrolling ability of the browser depending on the content being displayed in a browser. A first set of information is obtained from a browser, evidenced as being accessed by at least a user, comprising browser content. A second set of information is obtained comprising information related to the interests of at least the user. The second set of information may include information obtained from online social networks and the browsing history of at least the user. Using at least the first set of information, browser content corresponding to the second set of information is identified. In some embodiments, the identified browser content is highlighted and stored for future use. The browser scroll settings are then altered during the session. In some embodiments, the browser scroll settings are altered such that a user's ability to scroll through any identified browser content while displayed is slowed and the user's ability to scroll through the remaining browser content while displayed is quickened.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a block diagram illustrating one embodiment of the invention; and

FIG. 6 is a block diagram illustrating one embodiment of the invention.

### DETAILED DESCRIPTION OF THE DRAWINGS

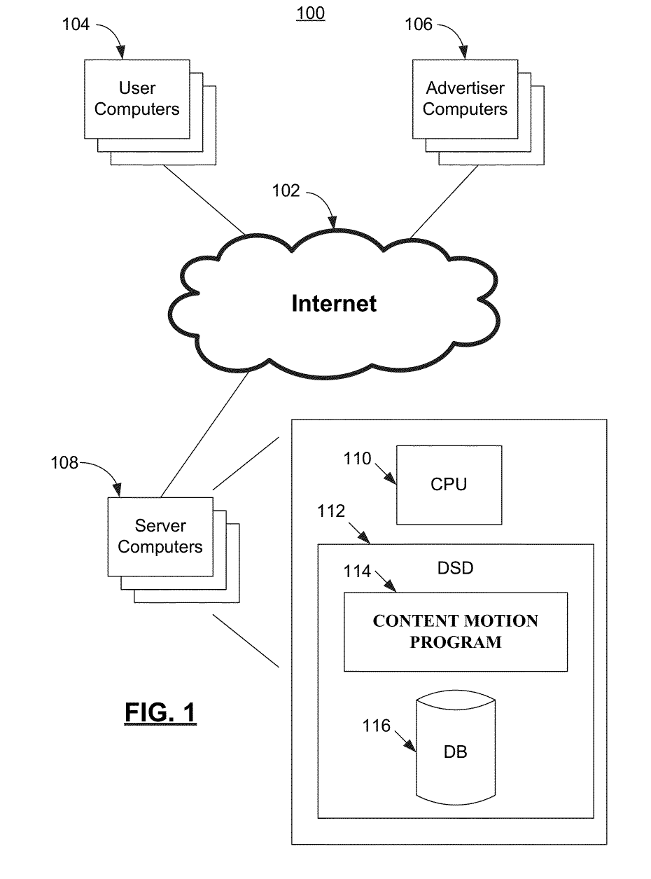

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Content Motion Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

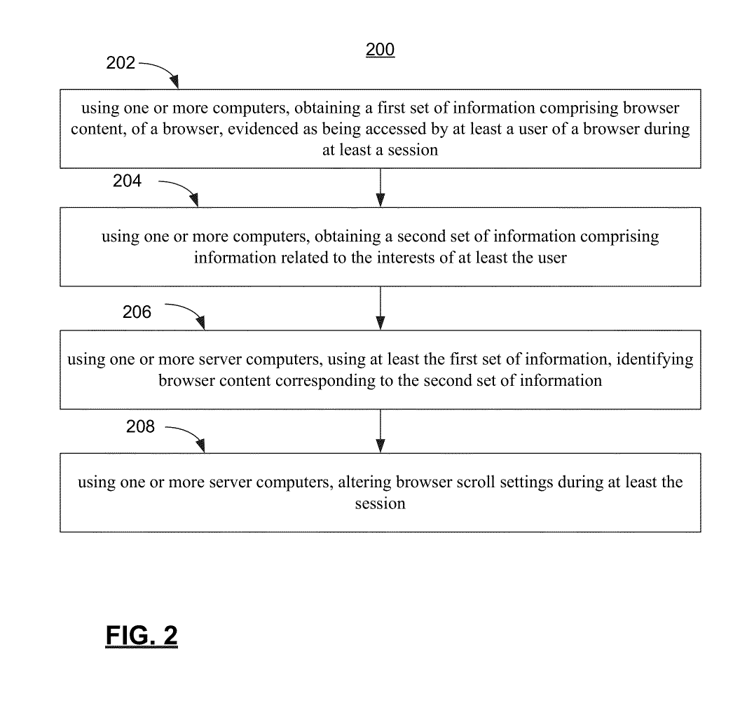

FIG. 2 is a flow diagram illustrating a method 200 according to one embodiment of the invention. At step 202, using one or more server computers, a first set of information is obtained from a browser, evidenced as being accessed by at least a user, comprising browser content.

At step 204, using one or more server computers, a second set of information is obtained comprising information related to the interests of at least the user. The second set of information may include information obtained from online social networks and the browsing history of at least the user.

At step 206, using one or more server computers, using at least the first set of information, browser content corresponding to the second set of information is identified. At step 208, using one or more server computers, the browser scroll settings are altered during at least the session.

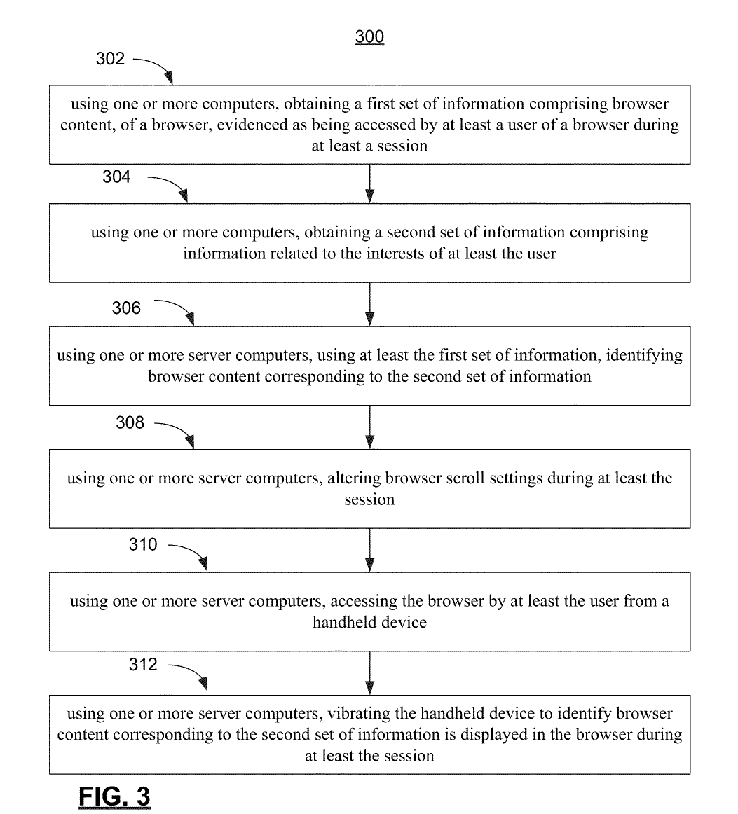

FIG. 3 is a flow diagram illustrating a method 300 according to one embodiment of the invention. At step 302, using one or more server computers, a first set of information is obtained from a browser, evidenced as being accessed by at least a user, comprising browser content.

At step 304, using one or more server computers, a second set of information is obtained comprising information related to the interests of at least the user. The second set of information may include information obtained from online social networks and the browsing history of at least the user.

At step 306, using one or more server computers, using at least the first set of information, browser corresponding to the second set of information is identified. At step 308, using one or more computers, the browser scroll settings are altered during at least the session. At step 310, using one or more server computers, the browser is accessed by at least the user from a handheld device. In some embodiments, a handheld device includes but is not limited to a mobile device, cell phone, tablet, PDA, or e-book reader. In 312, using one or more server computers, the handheld device vibrates to identify browser content corresponding to the second set of information is displayed in the browser during at least the session. In another embodiment, the handheld device emits a sound to identify the similar browser content.

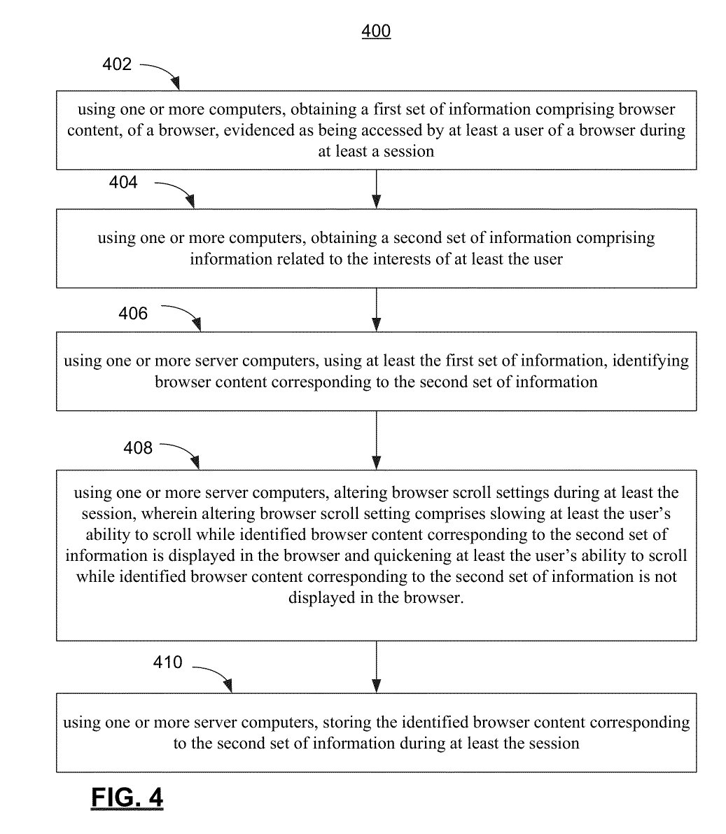

FIG. 4 is a block diagram 400 according to one embodiment of the invention. At step 402, using one or more server computers, a first set of information is obtained from a browser, evidenced as being accessed by at least a user, comprising browser content.

At step 404, using one or more server computers, a second set of information is obtained comprising information related to the interests of at least the user. The second set of information may include information obtained from online social networks and the browsing history of at least the user.

At step 406, using one or more server computers, using at least the first set of information, browser corresponding to the second set of information is identified. At step 408, using one or more server computers, the browser scroll settings are altered during at least the session. In one embodiment, the browser scroll settings are altered such that the user's ability to scroll through the identified browser content while displayed is slowed and the user's ability to scroll through the remaining browser content while displayed is quickened. At step 410, using one or more server computers, the identified browser content is stored.

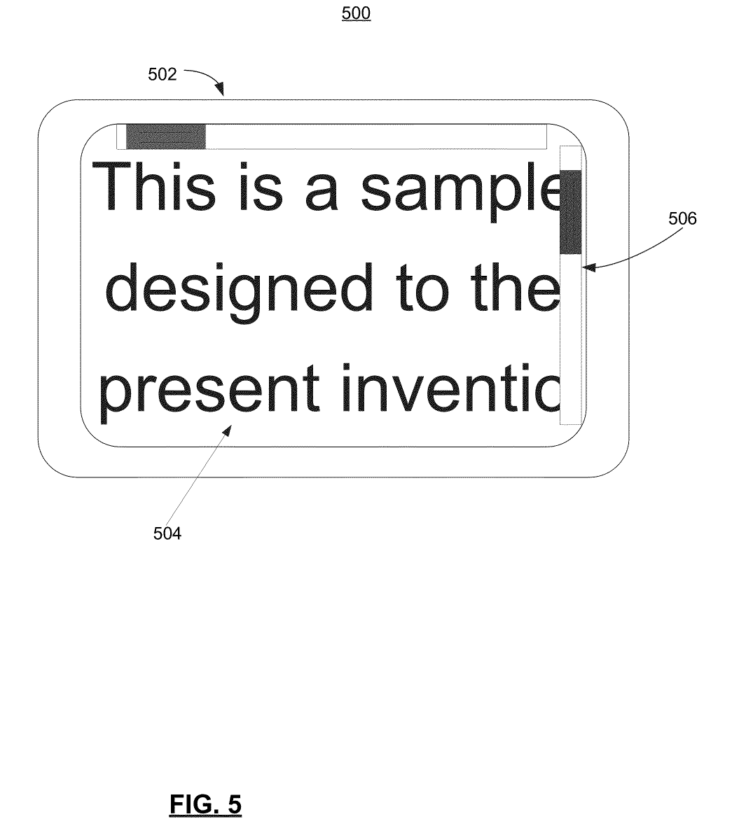

FIG. 5 is a block diagram 500 according to one embodiment of the invention. The handheld device 502 displays browser content 504 for the user to view. In one embodiment, scroll bars 506 are positioned vertically and/or horizontally to track the position in the browser content 504 being displayed and viewed by the user. Alternatively, the scroll bars 506 can be used to reposition the section of the browser content 504 being displayed in the handheld device 502.

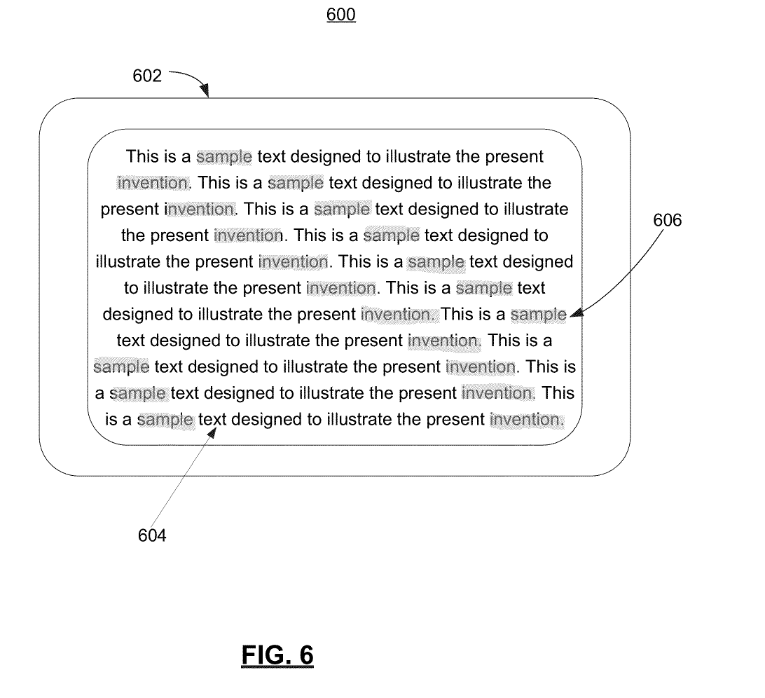

FIG. 6 is a block diagram 600 according to one embodiment of the invention. The handheld device 602 displays browser content 604 for the user to view. In one embodiment, browser content 604 corresponding to particular sets of information is identified and highlighted 606.

While the invention is described with reference to the above drawings, the drawings are intended to be illustrative, and the invention contemplates other embodiments within the spirit of the invention.

1-20. (canceled)

21. A system comprising one or more processors and a non-transitory storage medium comprising program logic for execution by the one or more processors, the program logic comprising:
a user interests programming module that, based at least in part on browsing history information for a user, obtains user interest information;
a page content identification programming module that, for a page comprising page content, identifies interest-corresponding page content, wherein the interest-corresponding page content is page content corresponding to the obtained user interest information; and
a scroll speed settings programming module that, with regard to an in-view portion of the page content, the in-view portion of the page content being all of the page content being viewed on a portable electronic device of the user, provides a slower scroll speed if the in-view portion of the page content includes interest-corresponding page content, relative to a scroll speed provided if the in-view portion of the page content does not include interest-corresponding page content.

22. The system of claim 21, wherein a slower scroll speed comprises at least one of a slower horizontal scroll speed and a slower vertical scroll speed.

23. The system of claim 21, wherein the page content comprises rich media content or video content.

24. The system of claim 21, wherein the in-view portion of the page content comprises rich media or video content.

25. The system of claim 21, wherein the obtained user interest information comprises a set of user interest words that correspond to user interests, and wherein the page content comprises words, and wherein the user-interest corresponding page content is content that includes one or more of the set of user interest words.

26. The system of claim 21, wherein, when the in-view portion of the page content changes from not including user-interest corresponding page content to including user-interest corresponding page content, scroll speed is decreased.

27. The system of claim 21, wherein, when the in-view portion of the page content changes from including user-interest corresponding page content to not including user-interest corresponding page content, scroll speed is increased.

28. The system of claim 21, wherein, when the in-view portion of the page content changes from not including user-interest corresponding page content to including user-interest corresponding page content, scroll speed is decreased and a user alert is provided, wherein the user alert comprises device vibration.

29. The system of claim 21, wherein, when the in-view portion of the page content changes from not including user-interest corresponding page content to including user-interest corresponding page content, scroll speed is decreased and a user alert is provided, wherein the user alert comprises an audible alert.

30. The system of claim 21, comprising visibly highlighting any user-interest corresponding page content included in the in-view portion of the page content.

31. The system of claim 21, comprising displaying an advertisement as part of the in-view portion of the page content, wherein the advertisement is targeted to the user at least by including interest corresponding content, wherein the interest corresponding content is content corresponding to the obtained user interest information.

32. The system of claim 21 comprising, based at least in part on browsing history information for a user and social networking activity information for the user, obtaining the user interest information.

33. The system of claim 21, wherein the page is a Web page, and wherein the scroll speed is Web browser scroll speed.

34. A method comprising:
based at least in part on browsing history information for a user, obtaining user interest information;
for a page comprising page content, identifying interest-corresponding page content, wherein the interest-corresponding page content is page content corresponding to the obtained user interest information; and
with regard to an in-view portion of the page content, the in-view portion of the page content being all of the page content being viewed on a portable electronic device of the user, slowing a scroll speed if the in-view portion of the page content changes from not including interest-corresponding page content to including interest-corresponding page content.

35. The method of claim 34, comprising increasing a scroll speed if the in-view portion of the page content changes from including interest-corresponding page content to not including interest-corresponding page content.

36. The method of claim 34, comprising, with regard to an in-view portion of the page content being viewed on a portable electronic device of the user, slowing a scroll speed if the in-view portion of the page content changes from not including interest-corresponding page content to including interest-corresponding page content, wherein the page is a Web page, and wherein the scroll speed is a browser scroll speed.

37. The method of claim 34, with regard to an in-view portion of the page content being viewed on a portable electronic device of the user, slowing a scroll speed if the in-view portion of the page content changes from not including interest-corresponding page content to including interest-corresponding page content, wherein the portable electronic device is a cell phone.

38. The method of claim 34, with regard to an in-view portion of the page content being viewed on a portable electronic device of the user, slowing a scroll speed if the in-view portion of the page content changes from not including interest-corresponding page content to including interest-corresponding page content, wherein the portable electronic device is a tablet computer.

39. The method of claim 34, with regard to an in-view portion of the page content being viewed on a portable electronic device of the user, slowing a scroll speed if the in-view portion of the page content changes from not including interest-corresponding page content to including interest-corresponding page content, wherein the portable electronic device is an e-book reader device, and wherein the patent content is e-book page content.

40. A non-transitory computer readable storage medium or media tangibly storing computer program logic capable of being executed by a computer processor, the program logic comprising:
user interests programming logic that obtains user interest information;
page content identification programming logic that, for a page comprising page content, identifies interest-corresponding page content, wherein the interest-corresponding page content is page content corresponding to the obtained user interest information; and
scroll speed settings programming logic that, with regard to an in-view portion of the page content being viewed on a portable electronic device of the user, provides a slower scroll speed if the in-view portion of the page content includes interest-corresponding page content, relative to a scroll speed provided if the in-view portion of the page content does not include interest-corresponding page content.
